(19) United States
(12) Patent Application Publication
(10) Pub. No.: US 2024/0302565 A1
(43) Pub. Date: Sep. 12, 2024

(54) METHOD FOR OPTIMIZING LITHIUM-POTASSIUM ANTICLINE STRUCTURE TARGET AREA

(71) Applicant: Bureau of Geology and Mineral Exploration and Development of Qinghai Province, Xining (CN)

(72) Inventors: Tong PAN, Xining (CN); Shaodong ZHANG, Xining (CN); Tingfeng GUO, Xining (CN); Jiantuan JIA, Golmud (CN); Xiaodong ZHANG, Golmud (CN); Yuxiang ZHAO, Golmud (CN); Deliang FU, Xi'an (CN); Jianqiang QIN, Xi'an (CN); Yuanhong HAN, Xi'an (CN)

(21) Appl. No.: 18/619,414

(22) Filed: Mar. 28, 2024

Related U.S. Application Data
(63) Continuation of application No. PCT/CN2023/079725, filed on Mar. 6, 2023.

(51) Int. Cl. G01V 20/00

(52) U.S. Cl. CPC G01V 20/00

(57) ABSTRACT

The application discloses a method for optimizing a lithium-potassium anticline structure target area, which includes the following steps: obtaining data of a historical lithium-potassium anticline structure area, and classifying the data of the historical lithium-potassium anticline structure area to generate classified data; carrying out a parameter assignment on the classified data to obtain a parameter data set; constructing a neural network model, inputting the parameter data set into the neural network model for a training, and obtaining a target area optimal neural network model; and based on the target area optimal neural network model, carrying out a target area optimization in a deep lithium-potassium anticline structure area, and obtaining an optimal result.

### CROSS-REFERENCE TO RELATED APPLICATIONS

This application is a continuation of PCT/CN2023/079725, filed on Mar. 6, 2023, the contents of which are incorporated herein by reference.

### TECHNICAL FIELD

The application belongs to the field of target area optimization, and in particular to a method for optimizing a lithium-potassium anticline structure target area.

### BACKGROUND

The screening and delineation of prospecting targets is not only the new content of metallogenic prognosis, but also the basic work that must be carried out in the early stage of general prospecting and the basis for the decision-making. The target area is minimized on the basis of optimizing the prediction marks, and the research on the ore-bearing rate of the target area is strengthened, so as to improve the ore-finding rate of drilling verification, improve the hit rate of discovering deposits (ore body) and improve the geological prospecting effect. Therefore, the delineation of the target area is based on the minimum area and the maximum ore content. Target area screening is a process of selecting the best and discarding the worst by further judging the possibility of finding deposits in each target area under the condition that the target area has been fixed.

The formation process of salt minerals is the coupling of “structure-material source-climate” in the earth's supergene environment, and the structure is the premise and material source is the necessary condition, and climate factor plays an important role in promoting the formation of salt minerals. Based on the coupling relationship of the above-mentioned salt-forming conditions, foreign scholars put forward “sandbar model”, “reserve basin model” and “abnormal sylvite evaporite” sedimentary model, and established corresponding target area optimization methods. Based on the investigation of potassium salt resources in China, domestic scholars put forward some models of salt formation and potassium formation, such as “high mountain and deep basin”, “water-containing wall” and “two-story building”. On the basis of the above, the target area optimization method and shallow Quaternary salt prospecting have achieved certain results, but the brine ore in anticline structure area (containing potassium and lithium) is the latest discovery in recent years, and the research work is not enough, and the prospecting prediction method is only the beginning.

### SUMMARY

The objective of the application is to provide a method for optimizing a lithium-potassium anticline structure target area, so as to solve the problems existing in the prior art.

In order to achieve the above objective, the application provides a method for optimizing a lithium-potassium anticline structure target area, which includes the following steps:
obtaining data of a historical lithium-potassium anticline structure area, and classifying the data of the historical lithium-potassium anticline structure area to generate classified data;
carrying out a parameter assignment on the classified data to obtain a parameter data set;
constructing a neural network model, inputting the parameter data set into the neural network model for a training, and obtaining a target area optimal neural network model; and
based on the target area optimal neural network model, carrying out a target area optimization in a deep lithium-potassium anticline structure area, and obtaining an optimal result.

Optionally, a process of generating the classified data includes:
obtaining the data of the historical lithium-potassium anticline structure area based on an existing database;
carrying out a feature identification on the data of the historical lithium-potassium anticline structure area to obtain feature data of a structure area; and
based on data features, carrying out a data classification on the feature data of the structure area to generate the classified data.

Optionally, the classified data includes material source data, anticline formation time data, lithofacies data, paleoclimatic condition data and buried depth data.

Optionally, a process of obtaining the parameter data set includes:
screening a classified data set based on different categories to obtain a screened data set; and
setting a data threshold range, and evaluating the screened data set based on the data threshold range to obtain the parameter data set.

Optionally, a process of obtaining the screened data set includes:
judging and identifying attribute description features of the screened data set to obtain an attribute data set;
splitting an attribute description in the attribute data set into character tuples, and then carrying out a clustering test to obtain category attribute weights;
performing an attribute similarity matching based on the category attribute weights to obtain an attribute matching result; and
matching the attribute matching result with the screened data set to obtain the screened data set.

Optionally, a process of obtaining the target area optimal neural network model includes:
dividing the parameter data set to generate a training set and a test set;
constructing the neural network model, and inputting the training set into the neural network model to obtain an optimal neural network model;
inputting the test set into the optimal neural network model for a testing, and generating a test result; and
based on the test result, fine-tuning the optimal neural network model to obtain the target area optimal neural network model.

Optionally, a process of obtaining the optimal result includes:
obtaining real-time data of a lithium-potassium anticline structure area, inputting the real-time data of the lithium-potassium anticline structure area into the target area optimal neural network model for a target area quality calculation, and obtaining a calculation result; and
setting a calculation threshold range, and comparing the calculation result with the calculation threshold range to obtain the optimal result.

Optionally, a process of comparing the calculation result with the calculation threshold range to obtain the optimal result includes:
dividing the calculation threshold range into a first calculation threshold range, a second calculation threshold range and a third calculation threshold range based on a weighted value range; and
comparing the calculation result with the calculation threshold range, and a first optimal result is considered if the calculation result is within the first calculation threshold range, a second optimal result is considered if the calculation result is within the second calculation threshold range, and a third optimal result is considered if the calculation result is within the third calculation threshold range.

The application has the following technical effects.

Firstly, the method for optimizing the lithium-potassium anticline structure target area provides theoretical and technical support for the prospecting direction of potassium-lithium brine anticline structure.

Besides, the method for optimizing the lithium-potassium anticline structure target area has promoted the breakthrough of geological prospecting in areas with extremely low working level and underdeveloped national economy in the western region, and has provided the basis for the guarantee of national potassium salt resources.

Moreover, the lithium-potassium anticline structure target area is optimized by the neural network, which greatly reduces the error, indicating a great significance for systematically evaluating the potential of strategic mineral resources in the salt lake as well as supporting the mining industry and promoting industrial transformation and upgrading.

### BRIEF DESCRIPTION OF THE DRAWINGS

The attached drawings, which constitute a part of this application, are used to provide a further understanding of this application. The illustrative embodiments of this application and their descriptions are used to explain this application, and do not constitute an improper limitation of this application. In the attached drawings:

FIG. 1 is a flowchart for optimizing a lithium-potassium anticline structure target area in an embodiment of the present application.

FIG. 2 is a schematic diagram of constructing a neural network in an embodiment of the present application.

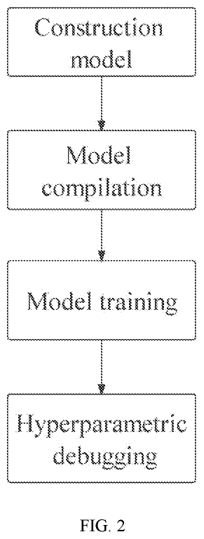

### DETAILED DESCRIPTION OF THE EMBODIMENTS

It should be noted that the embodiments in this application and the features in the embodiments may be combined with each other without conflict. The present application are described in detail with reference to the attached drawings and embodiments.

It should be noted that the steps shown in the flowchart of the attached drawings may be executed in a computer system such as a set of computer-executable instructions, and although the logical order is shown in the flowchart, in some cases, the steps shown or described may be executed in a different order from here.

### Embodiment 1

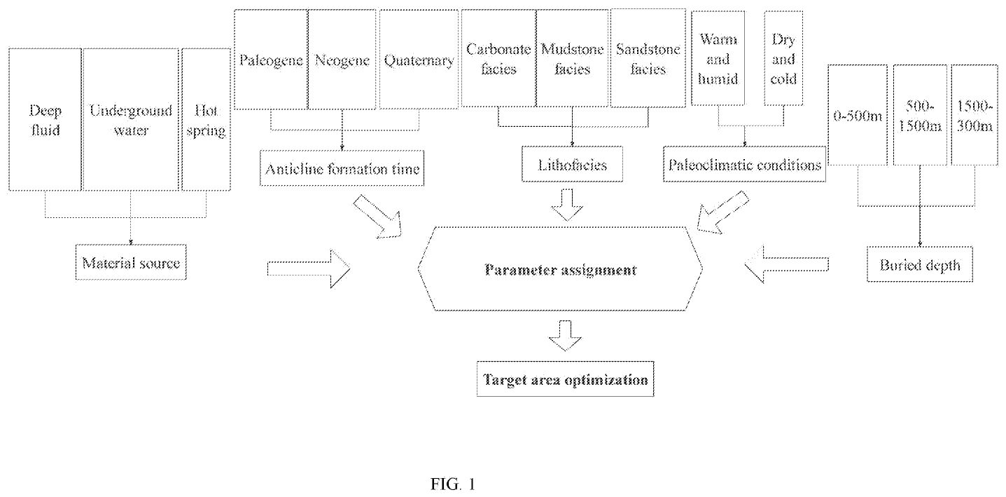

As shown in FIG. 1, a method for optimizing a lithium-potassium anticline structure target area is provided in this embodiment, including:
obtaining data of a historical lithium-potassium anticline structure area, and classifying the data of the historical lithium-potassium anticline structure area to generate classified data;
carrying out a parameter assignment on the classified data to obtain a parameter data set;
constructing a neural network model, inputting the parameter data set into the neural network model for a training, and obtaining a target area optimal neural network model; and
based on the target area optimal neural network model, carrying out a target area optimization in a deep lithium-potassium anticline structure area, and obtaining an optimal result.

In a further optimization scheme, a process of generating the classified data includes the following steps:
obtaining the data of the historical lithium-potassium anticline structure area based on an existing database, where the the obtaining of the data of the historical lithium-potassium anticline structure area in this embodiment is divided into the following five aspects.
1. The material sources of groundwater, hot springs and deep fluids are collected: because all kinds of materials on the earth, including ore-forming materials, are always in motion, the mineral source is a dynamic concept, which changes with the geological space-time evolution; the change of mineral sources in space is manifested as different types of mineral sources in different tectonic environments, and the change of mineral sources in geological time is expressed by the difference of several main mineral sources in different geological periods. The contribution of various elements to ore-forming in different tectonic environments is analyzed and the main sources of ore-forming materials are determined.

Taking the Qaidam Basin as an example, the main mineral source of the deep lithium-potassium brine in the anticline structure area is the deep fluid, followed by the sealed groundwater. Hot springs provide rich mineral-forming sources, but mainly by supplying shallow minerals. The migration of deep fluid may only effectively migrate to the target reservoir by means of structural channels, so interpreting faults according to seismic exploration or other effective means is the primary means of this prediction scheme. Deep faults that go deep into the basement may be identified as large faults that are most beneficial to the source of deep materials, and a score of 85-100 is assigned, and the existence of such faults is favorable, and multiple faults may be given high scores; faults that cut through Paleogene-Neogene reservoirs are conducive to the migration of material sources, and a score of 75-84 is assigned, similarly, score is assigned according to the development degree of such structures; the structure area with undeveloped faults is mainly the long-term water-rock exchange between groundwater and ore-bearing surrounding rocks, and the material source is limited, and a score of 60-75 is assigned. After investigation, the joint action of groundwater and hot spring supply is more favorable, and a higher score may be taken in this assignment range, and it may not be proved that the action of groundwater or hot spring is existed, and the value is less than 60 scores.
2. Formation time of anticline structure: the ore-forming materials (fluids) of deep brine are transported to the storage area for concentration after a certain distance, which is basically the carrying and transmission of various geological fluids. Combined with the dynamics, channels, dynamic processes and chemical composition evolution of ore-forming fluids, it is concluded that the migration process and composition changes of potassium-lithium brine are stored in anticline structures formed at a specific time to form reservoirs.

Still taking the Qaidam Basin as an example, the basin went through the Paleocene-Miocene extensional subsidence stage, the Pliocene (Oil-Sand Mountain Stage) regional compression depression stage, and the late Pliocene (Shizigou Stage)-Quaternary compression, nappe and local strike-slip stage, forming anticline structures with different times and styles. Palcogene-Neogene is the most favorable metallogenic period. According to seismic exploration interpretation or other effective means, the Paleocene-Pliocene stratum thickness is more than 2,000 m, and a score of 85-100 is assigned; when the strata thickness reaches 1,000-2,000 m, a score of 75-84 is assigned; when the strata thickness is 500-1,000 m, a score of 60-74 is assigned; when the strata thickness is less than 500 m, a score less than 60 is assigned; the existing data proves that only Quaternary strata may not be mineralized, and the assigned score is 0.
3. Sedimentary facies: deep brine reservoirs mainly include carbonate rocks and clastic rocks, and clastic rocks are the main ones. High-quality and effective reservoirs are closely related to lithofacies. The determination of lithofacies needs to be comprehensively determined by preliminary positioning of sedimentary facies, collecting logging data, etc. Potassium-lithium brine reservoirs are mostly developed in delta facies and inshore shallow lake facies, especially in delta area, where there are many types of sand bodies and good reservoir properties.

Again taking the Qaidam Basin as an example, the potassium-lithium anticline structure was formed in the Paleogene-Neogene sedimentary period, and it was continuously replenished by the potassium-lithium water system around the basin, and always maintained a huge water body with deep lake, shallow lake and lakeside sediments, which is beneficial to the concentration and differentiation of brine and the relative enrichment of potassium. The Pliocene climate was dry and the lake water was concentrated. In the western part of the basin, gypsum, halite and other salt deposits were deposited. The concentration of potassium-lithium brine may be analyzed from alluvial piedmont residual zone, alluvial accumulation zone and shallow lake subfacies respectively. There are two types of brine reservoirs in Qaidam Basin, namely carbonate rocks and clastic rocks, and the clastic rocks are the main ones. Carbonate reservoirs are only developed in a small area in the west. Carbonate reservoirs have good storage performance due to the development of dissolved pores, and glutenite and sandstone are the best effective reservoirs in clastic reservoirs. The determination of lithofacies needs to be comprehensively determined by preliminary positioning of sedimentary facies and collecting logging data. When the thickness of carbonate rock+glutenite+sandstone reaches more than 300 m, a score of 85-100 may be assigned; when the thickness of carbonate rock+glutenite+sandstone is 100-300 m, a score of 60-84 may be assigned; when the thickness of carbonate rock+glutenite+sandstone is less than 100 m, a score less than may be assigned; mudstone is an ineffective reservoir.
4. Palcoclimatic conditions: for salt ore-forming, the overall dry climatic conditions are that the evaporation is greater than the precipitation, which may concentrate the lake water and increase the salinity, which is more conducive to ore-forming. However, the palacoenvironment varied considerably with the migration of the lake basin, and the local climate varied considerably in different areas within the basin, which depends on the comprehensive analysis of paleoclimate and lithofacies palacogeography, and the microenvironment climate of different anticline structural areas may be judged.

Reffering to the example of Qaidam Basin, the Qaidam area was in Oligocene, and the paleoclimate was cold and dry. During Miocene-Pliocene, the climate was extremely cold and dry, the recharge decreased, the evaporation and concentration of ancient lake water intensified, the salinity increased rapidly, the Cenozoic strata in the basin contracted and folded, and under the high pressure and closed reducing environment, the structural fracture-pore brine mine was formed in the anticline structure area. The reservoir formed in arid environment is assigned more than 85 scores, and the reservoir formed in humid environment is assigned 60-85 scores, and the detailed assignment is made according to the lithofacies paleogeography of the prediction target area within the assignment range.
5. Buried depth: the buried depth of the ore body refers to the vertical distance from the earth's surface to the upper boundary of the ore body. The buried depth of the deposit may directly reflect the cover conditions of deep brine, and has great influence on development and utilization and economic benefits. Therefore, it is divided into 0-500 m, 500-1500 m and 1500-3000 m for assignment.

A feature identification is carried out on the data of the historical lithium-potassium anticline structure area to obtain feature data of a structure area;
based on the data features, a data classification is carried out on the feature data of the structure area to generate the classified data. The classification process is mainly divided into two parts. Firstly, MPCA is used to extract the tensor of the original sample, and GTDA algorithm is used in the effective reduced subspace to output the final feature subspace.

In a further optimization scheme, the classified data includes material source data, anticline formation time data, lithofacies data, paleoclimatic condition data and buried depth data.

In a further optimization scheme, a process of obtaining the parameter data set includes:
screening a classified data set based on different categories to obtain a screened data set; and
setting a data threshold range, and evaluating the screened data set based on the data threshold range to obtain the parameter data set.

In a further optimization scheme, a process of obtaining the screened data set includes:
judging and identifying attribute description features of the screened data set to obtain an attribute data set;
splitting an attribute description in the attribute data set into character tuples, and then carrying out a clustering test to obtain category attribute weights;
performing an attribute similarity matching based on the category attribute weights to obtain an attribute matching result; and
matching the attribute matching result with the screened data set to obtain the screened data set.

In a further optimization scheme, a process of obtaining the target area optimal neural network model includes:
the parameter data set is divided to generate a training set and a test set;
the neural network model is constructed, and the training set is input into the neural network model to obtain an optimal neural network model.

The construction of model structure mainly includes the design of neural network structure, the selection of activation function, how to initialize model weights, whether the network layer is standardized or not, and the setting of regularization strategy. Then, the model compilation is performed, mainly including the setting of learning objectives and optimization algorithms. Finally, the model training and hyperparameter debugging are performed, mainly including the division of data sets, the hyperparameter adjustment and training. The model includes input layer, hidden layer and output layer. The performance of the model with different layers and the number of neurons (calculation units) will also be different, where:
input layer is the data feature input layer, and the feature dimension of input data corresponds to the number of neurons in the network;
hidden layer is the middle layer of the network, and is used to to accept the output of the previous layer as the current input value and calculate and output the current result to the next layer; the number of hidden layers and neurons directly affects the fitting ability of the model;
and output layer is the network layer that outputs the final result.

In a further optimization scheme, the number of neurons in the model structure, the number of neurons in the input layer and the number of neurons in the output layer are determined in this embodiment, and the depth and width of the hidden layer are considered in this embodiment. On the premise of ignoring the network degradation problem, the more neurons in the hidden layer of the neural network model in this embodiment, the more capacity the model has to achieve a better fitting effect. To search for the appropriate network depth and width, there are commonly methods such as manual empirical parameter adjustment, random/grid search, Bayesian optimization, etc. In this embodiment, Bayesian optimization method is adopted because the data situation is complicated.

The test set is input into the optimal neural network model for a testing, and a test result is generated;
based on the test result, the optimal neural network model is fine-tuned to obtain the target area optimal neural network model.

In a further optimization scheme, a process of obtaining the optimal result includes:
obtaining real-time data of the lithium-potassium anticline structure area, inputting the real-time data of the lithium-potassium anticline structure area into the target area optimal neural network model for a target area quality calculation, and obtaining a calculation result; and
setting a calculation threshold range, and comparing the calculation result with the calculation threshold range to obtain the optimal result.

In a further optimization scheme, a process of comparing the calculation result with the calculation threshold range to obtain the optimal result includes:
dividing the calculation threshold range into a first calculation threshold range, a second calculation threshold range and a third calculation threshold range based on a weighted value range; and
comparing the calculation result with the calculation threshold range, and a first optimal result is considered if the calculation result is within the first calculation threshold range, a second optimal result is considered if the calculation result is within the second calculation threshold range, and a third optimal result is considered if the calculation result is within the third calculation threshold range.

Combined with the conditions of caprock and the economic benefits of development and utilization, in the range of buried depth of 500-1,500 m in Qaidam basin, the preservation conditions are generally good, and the economic significance of development and utilization is great, a score of 85-100 is assigned; when the burial depth is 1,500-3,000 m, the preservation condition is good, but the development cost is high, and a score of 60-84 is assigned; when the burial depth is 0-500 m, the development and utilization cost is low, and in general, the preservation conditions are poor and the brine quality is poor.

The above five variables are assigned with the material source of 40%, the formation time of anticline structure of 20%, sedimentary facies of 15%, paleoclimatic conditions of 10% and buried depth of 15% respectively.

If the weighted value of five variables in each target area is ≥85, the target area is a class A target area, basically may be determined as a ore-bearing structure area, and is the optimal exploration area; if 60≤weighted value<85, the target area is a class B target area, and the probability of making a breakthrough in prospecting is high, so it is a secondary exploration verification area; if the weighted value is <60, the target area is a Class C target area with certain exploration risk, and may be put into appropriate work for verification.

In order to achieve the above objectives, the following basic principles may be adhered to in optimizing the lithium-potassium anticline structure target area.
1. Principle of authenticity

It is consistent with the original data and the ore-forming facts of potassium-lithium brine in anticline structure, and the reasons for the inconsistency may be explained.
2. Principle of normalization

The technical requirements and other standards may be uniformly implemented, and the format, legend and color standard lines may be unified.
3. Principle of applicability

Full attention may be paid to serving the needs of target area optimization and prospecting, being easy to understand and flexible to operate. One drawing is used to represent each key stage, overlapping may be avoided.
4. Principle of materiality

For the important anticline structures with small exposed area, data may be fully collected and depth analysis is made.
5. Principle of aesthetic

Based on the objective, true and standardized expression of various geological elements, the work flow is reasonable, the density is appropriate, being neat and beautiful.

The above is only the optimal embodiment of this application, but the protection scope of this application is not limited to this. Any change or replacement that may be easily thought of by a person familiar with this technical field within the technical scope disclosed in this application should be covered by this application. Therefore, the protection scope of this application should be based on the protection scope of the claims.

What is claimed is:

1. A method for optimizing a lithium-potassium anticline structure target area, comprising the following steps:
obtaining data of a historical lithium-potassium anticline structure area, and classifying the data of the historical lithium-potassium anticline structure area to generate classified data;
carrying out a parameter assignment on the classified data to obtain a parameter data set;
constructing a neural network model, inputting the parameter data set into the neural network model for a training, and obtaining a target area optimal neural network model; and
based on the target area optimal neural network model, carrying out a target area optimization in a deep lithium-potassium anticline structure area, and obtaining an optimal result.

2. The method for optimizing the lithium-potassium anticline structure target area according to claim 1, wherein a process of generating the classified data comprises:
obtaining the data of the historical lithium-potassium anticline structure area based on an existing database;
carrying out a feature identification on the data of the historical lithium-potassium anticline structure area to obtain feature data of a structure area; and
based on data features, carrying out a data classification on the feature data of the structure area to generate the classified data.

3. The method for optimizing the lithium-potassium anticline structure target area according to claim 2, wherein
the classified data comprises material source data, anticline formation time data, lithofacies data, paleoclimatic condition data and buried depth data.

4. The method for optimizing the lithium-potassium anticline structure target area according to claim 1, wherein a process of obtaining the parameter data set comprises:
screening a classified data set based on different categories to obtain a screened data set; and
setting a data threshold range, and evaluating the screened data set based on the data threshold range to obtain the parameter data set.

5. The method for optimizing the lithium-potassium anticline structure target area according to claim 4, wherein a process of obtaining the screened data set comprises:
judging and identifying attribute description features of the screened data set to obtain an attribute data set;
splitting an attribute description in the attribute data set into character tuples, and then carrying out a clustering test to obtain category attribute weights;
performing an attribute similarity matching based on the category attribute weights to obtain an attribute matching result; and
matching the attribute matching result with the screened data set to obtain the screened data set.

6. The method for optimizing the lithium-potassium anticline structure target area according to claim 1, wherein a process of obtaining the target area optimal neural network model comprises:
dividing the parameter data set to generate a training set and a test set;
constructing the neural network model, and inputting the training set into the neural network model to obtain an optimal neural network model;
inputting the test set into the optimal neural network model for a testing, and generating a test result; and
based on the test result, fine-tuning the optimal neural network model to obtain the target area optimal neural network model.

7. The method for optimizing the lithium-potassium anticline structure target area according to claim 1, wherein a process of obtaining the optimal result comprises:
obtaining real-time data of a lithium-potassium anticline structure area, inputting the real-time data of the lithium-potassium anticline structure area into the target area optimal neural network model for a target area quality calculation, and obtaining a calculation result; and
setting a calculation threshold range, and comparing the calculation result with the calculation threshold range to obtain the optimal result.

8. The method for optimizing the lithium-potassium anticline structure target area according to claim 7, wherein a process of comparing the calculation result with the calculation threshold range to obtain the optimal result comprises:
dividing the calculation threshold range into a first calculation threshold range, a second calculation threshold range and a third calculation threshold range based on a weighted value range; and
comparing the calculation result with the calculation threshold range, and a first optimal result is considered if the calculation result is within the first calculation threshold range, a second optimal result is considered if the calculation result is within the second calculation threshold range, and a third optimal result is considered if the calculation result is within the third calculation threshold range.
